(19) United States
(12) Patent Application Publication
(10) Pub. No.: US 2013/0125725 A1
(43) Pub. Date: May 23, 2013

(54) STEEL PUNCH KNIFE

(71) Applicants: Daniel Roos, Forsbacka (SE); Sven-Inge Mattsson, Sandviken (SE)

(72) Inventors: Daniel Roos, Forsbacka (SE); Sven-Inge Mattsson, Sandviken (SE)

(73) Assignee: SANDVIK INTELLECTUAL PROPERTY AB, Sandviken (SE)

(21) Appl. No.: 13/636,060

(22) PCT Filed: Jul. 16, 2010
(86) PCT No.: PCT/SE2010/050851

§ 371 Date: Oct. 11, 2012

(30) Foreign Application Priority Data
Mar. 23, 2010 (SE) 1050274-8

(51) Int. Cl. B26F 1/14

(52) U.S. Cl. CPC B26F 1/14
USPC 83/684

(57) ABSTRACT

The steel punch knife according to the invention is suitable for punching out parts of any shape from paper, cardboard, paperboard, corrugated board, plastics sheets, leather rubber and the like, and comprises a knife body (4) with a cutting edge (2) at one end and a deformable back portion (3) opposite the cutting edge (2). The cutting edge (2) is harder than at least a portion of the back portion (3). The back portion (3) comprises a V-shaped back edge (3b) having two inclined sides defining an inclination angle between them. The maximum width of the back edge (3b), at the base thereof, is smaller than the width of the knife body (4), such that there is a shoulder (9) where the back edge (3b) meets the knife body (4).

### TECHNICAL FIELD

The present invention relates to a steel punch knife for punching out parts of any shape from paper, cardboard, paperboard, corrugated board, plastics sheets, leather rubber and the like. In particular the present invention relates to a punch knife with a self levelling function provided by controlled deformation of a portion of the knife. said punch knife comprising: a cutting edge, a V-shaped back portion having an edge and two inclined sides defining an inclination angle between them, and a knife body separating the cutting edge from the back portion, and wherein the cutting edge is harder than the back portion.

### BACKGROUND OF THE INVENTION

Die cutting machines for cutting out profiles of any shape from paper, cardboard, paperboard, plastics sheets, leather rubber and the like are well known. Typically a die cutting machine comprises an elongated metal rule which forms a so-called punch knife by means of which the material in question is punched and given its shape. The punch knife is a metal band, typically a carbon steel band, which has a main body with two opposite, parallel sides, a cutting edge and a back portion opposite to the cutting edge. The punch knife is also commonly refereed to as a steel rule or die cutting rule. It may be of considerable length, e.g. more than one meter, and even up to ten, twenty or thirty meters. The punch knife is bent to a shape that corresponds to the profile of the object to be punched out, for example into a rectangular shape. Typically, a die cutting machine comprises an upper bed in contact with a flat upper plate, the chase plate, which is in supporting contact with the back portion of the punch knife and which is arranged so as to transfer the force to the punch knife that is needed for the punching operation. A die cutting machine also comprises a die board that is placed adjacent to the chase plate and which has the function of a fixture that firmly holds the punch knife in a lateral direction. The die board is provided with slots through which the punch knife protrudes and may typically be of wooden material. The die cutting machine also comprises a flat lower plate, the cutting plate, which carries the material to be punched and is arranged so as to move towards the cutting edge of the punch knife until it comes into contact with the cutting edge. In order to achieve a complete cut through, the cutting edge should get into continuous contact with the cutting plate along its length. However, this might be difficult to achieve and local high and low spots appear due to manufacturing tolerances and normal wear of the cutting machine. Typically such imperfections are in the order of 0.1 mm, and results in areas wherein a complete cut through is not achieved.

Die cutting technology has always involved a time-consuming and elaborate technique of leveling the die board and get a clean cut through cardboard, for example. This technique is called “patch up” and consists of a number of test punches and intermediate exercises of examining the result and compensating for variations in cutting result along the steel punch knife/knives. The compensation is done by adding thin strips of sheet material, e.g. tape, typically on a plastic sheet that is positioned between the chase plate and the upper bed, in areas relating to sections of the steel punch knife where a complete cut through are not achieved. The process, in addition to being time consuming, requires a highly skilled and trained operator. It has in the prior art been suggested, in order to decrease the need for patch up, to introduce punch knives wherein the back portion comprises a protruding back structure. The protruding back structure is designed to deform slightly during operation, whereas the cutting edge is left substantially without any deformation. This allows for a steel punch knife to become self-leveling. To enable the protruding back structure to deform under pressure the cutting edge must be able to withstand a higher pressure than the protruding back structure. In prior art this is achieved by hardening the cutting edge, while the protruding back structure is heat treated to a lower hardness than the rest of the punch knife. Moreover, there have been suggested numerous back profiles designed so as to promote collapse of the back portion when subjected to pressure, and hence compensate for tolerance faults that would otherwise require “patch up”, se for example DE102008025606 and DE3135980. The proposed solutions require extensive changes in the handling of the punch knife and/or when producing the die board.

Before being mounted in the die cutting machine the punch knife is mounted in the die board. The slots in the die board that are to accommodate the punch knife extend all way through the die board in the thickness direction thereof. When the punch knife is to be mounted in die board, the die board is placed on a suitable supporting surface such as a table with a hard and even surface, for example a steel table. The punch knife, or any segment thereof, is pressed into the slot of the die board until the back portion (back edge) of the knife is in linear contact with the supporting surface, i.e. the table on which the die board rests. The mounting is very much of a craftsmanship and the knife is knocked into the slots bit by bit, such that local sites of enhanced load will appear on the back portion of the knife as those portions are forced into contact with the underlying table surface. Accordingly, a considerable pressure is applied to the knife, and there is a considerable risk that parts of the back portion will be subjected to a permanent deformation.

### SUMMARY OF THE INVENTION

It is an object of the present invention to present a steel punch knife that has a design that results in a self-levelling ability of the knife when subjected to a punching operation. The self-levelling ability should result from a controlled plastic deformation of a back portion of the punch knife Further, the design must be such that it reduces the risk of obtaining a permanent deformation of the back portion of the punch knife in connection to the mounting of the punch knife in a die board.

The object of the present invention is achieved by means of a punch knife as defined in claim 1.

The steel punch knife according to the invention comprises a knife body with a cutting edge at one end and a deformable back portion opposite the cutting edge. The cutting edge is harder than at least a portion of the back portion. The back portion comprises a V-shaped back edge having two inclined sides defining an inclination angle between them. The maximum width of the back edge, at the base thereof, is smaller than the width of the knife body, such that there is a shoulder where the back edge meets the knife body.

The shoulder is taken advantage of during the mounting of the punch knife in the die board in the respect that an intermediate deformable plate with a thickness slightly larger than the height of the back edge may be arranged between the die board and the supporting surface against which the die board rests during punch knife mounting, wherein the back edge is permitted to cut into the intermediate plate but the shoulder will bear on the intermediate plate and, at least to a certain degree, prevent further motion and deformation of the back edge.

One advantage afforded by the punch knife according to the invention is that it can be handled during all parts of the procedure, including bending and mounting operations, in the same way as the traditional knives. Apart from the introduction of the intermediate deformable plate during the mounting procedure, no further modification of existing equipment is needed.

Provided that the shoulder is wide enough and the back edge has a reasonably low height, the shoulder will also prevent an operator from being cut by the back edge when handling the knife. Typically the dimensions of the shoulder and the back edge are such that the latter will not cut through a normally thick skin of a human finger thanks to the presence of the shoulder.

According to a preferred embodiment, the back edge presents a symmetric cross section and has a centre plane which is coplanar with a centre plane of the knife body. Thereby, there is provided one shoulder on each side of the back edge, said shoulders preferably being identical and thereby contributing to the symmetry of the cross section of the punch knife. Symmetry is advantageous both from a functional and a manufacturing point of view. In particular, it is of advantage that the punch knife presents a similar behaviour independent of in which direction it is bent when formed to the shape that it is to have in a die cutting machine.

Preferably, the intersection between the sides of the back edge and a surface forming said shoulder is not sharp, but slightly rounded. This makes this transition region being less prone to cracking when the knife is subjected to a bending operation, typically in connection to the mounting of the punch knife. Preferably, the intersection between the sides of the back edge and the surface forming said shoulder has a radius in the range of 5-50 μm.

It is also preferred that the intersection between the surface of the shoulder and the sides of the knife body is rounded. This feature helps to improve the ability of the punch knife to smoothly go into the slot of the die board during assembly, without any cutting interaction with the latter. Preferably the intersection between the surface of the shoulder and the sides of the knife body presents a radius in the range of 100-250 μm.

It is also preferred that, in a region in which the shoulder meets a side of the knife body, the knife body has a width which is smaller than the maximum width thereof, and said side of the knife body is inclined with respect to a centre plane of the knife body. Thereby, the punch knife becomes even less likely to get stuck and therefore becomes easier to mount in the die board.

According to a preferred embodiment of the punch knife of the present invention, the inclination angle between the inclined sides of the back edge is in the range of 30°-70°, and the edge of the back edge is sharp, having a radius in the range of 1-10 μm.

In particular, the combination of a sharp edge and the suggested angle between the inclined sides of the back edge results in a stable but yet readily compressible back portion. Preferably, the back portion is formed as a single portion, having a central plane that is coplanar with a central plane of the knife body, such a design being advantageous from, i.a., a manufacturing point of view. It is preferred that the back edge of the back portion extends along a continuous line in a longitudinal direction of the knife, such that continuous line contact is obtained between the back edge and a support against which it bears.

According to one embodiment, the inclination angle between said inclined sides is equal to or more than 40°, preferably equal to or more than 50°. Thereby, the stability of the back edge against unwanted fall out to any side when subjected to pressure is further improved.

Preferably, the inclination angle between said inclined sides is equal to or less than 60°. Thereby, a further improved compressibility is achieved.

According to one embodiment the radius of the edge of the back edge is equal to or less than 5 μm. A smaller radius will further improve initial compressibility of the back edge.

Preferably, the back edge has a hardness that is equal to or below 320 HV, preferably equal to or lower than 300 HV, and even more preferably around 280 HV. Thereby, sufficient compressibility is provided for. The back edge is softer than the knife body, as a result of a heat treatment process that it is subjected to during manufacture, preferably an annealing process.

According to one embodiment, the back edge has a hardness that is equal to or higher than 250 HV.This lower limit is related to the material chosen as the knife material, namely carbon steel, preferably of grade CK55 (DIN standard), and the possible softening thereof by means of annealing.

Preferably, the cutting edge has a hardness that is equal to or higher than 500 HV, preferably equal to or higher than 600 HV or even 640 HV. A lower hardness results in a cutting edge more prone to deformation, which should be avoided since deformation thereof will affect the cutting performance of the cutting edge negatively.

According to one aspect of the invention cutting edge has a hardness that is equal to or lower than 740 HV, preferably equal to or lower than 700 HV. A too high hardness will result in a too brittle cutting edge, which would be prone to cracking when subjected to bending operations during forming of the punch knife to its final shape.

Further features and advantages of the present invention will be presented in the following detailed description, and in the independent patent claims.

### BRIEF DESCRIPTION OF THE DRAWINGS

An embodiment of the present invention will be presented with reference to drawing on which:

FIG. 1 is a partial cross section of a punch knife according to the invention;

FIG. 2 is a partial cross section of a punch knife according to the invention upon mounting in a die board;

FIG. 3 is a partial cross section of a punch knife according to the invention after mounting the die board with the punch knife in the cutting machine; and

FIG. 4 is a partial cross section of a die cutting machine provided with a punch knife according to the invention.

### DETAILED DESCRIPTION OF THE INVENTION

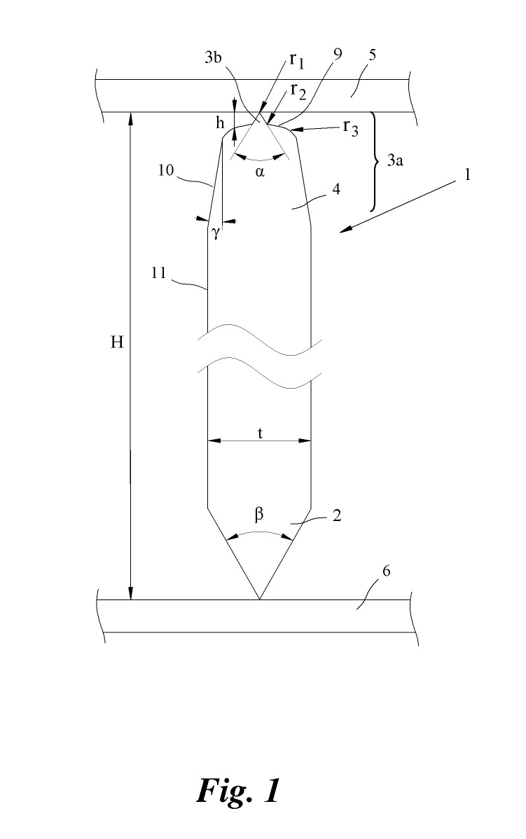

FIG. 1 shows the cross section of a punch knife 1 according to the present invention. The cross section shows the profile of the knife cross wise to its longitudinal direction. The punch knife is used for the purpose of cutting sheets of materials such as paper, paper board, card board, corrugated board, plastics sheets, leather, rubber etc to any shape, normally to a final shape. The steel punch knife 1 is particularly suitable for the purpose of being used for the punching of card board. However other materials may be punched with only minor modifications of the design, such modifications being obvious for the skilled persons. The die cutting machine in which the punch knife 1 is arranged is typically a stamping type in which the punch knife 1 is subjected to a linear motion towards the material to be punched. The steel punch knife according to the invention will hereinafter be described with reference to such die cutting machine. Alternatively the steel punch knife according to the invention can be utilized in a die cutting machine of a rotating type in which the punch knife 1 is carried by a roll and arranged so as to roll against the material to be punched.

The punch knife 1 is made of steel, preferably carbon steel, preferably of grade CK55 (DIN standard) or any corresponding grade.

The punch knife according to the invention comprises a cutting edge 2, a back portion 3a, and an intermediate knife body 4 located between the cutting edge 2 and the back portion 3a. The knife 1 has been formed out of one homogenous steel sheet, the cutting edge 2 and the back portion 3a being formed by means of machining operations. The knife body 4 presents two opposite sides that are parallel. The knife 1 has a considerable length, and its shape reminds of that of a rule. It may be bent to a final shape that corresponds to the contour of any product that is to be formed by means of punching with the punch knife 1.

The height H of the knife body 4, which forms the major part of the punch knife 1, is in the range of 20-40 mm, while the thickness t thereof is in the range of 0.4-1.5 mm. Suitable dimensions are chosen based on what kind of material that is to be punched. The knife body's hardness is in the range of 300-420 HV depending on which specific steel is chosen, and depending on which specific heat treatment it has been subjected to.

In order to provide for self levelling of the knife 1 upon punching operation, the back portion 3a of the knife is designed so as to plastically deform, while the cutting edge 2 retains its shape. This is achieved through a combination of hardness and geometric features of the cutting edge 2 and the back portion 3a respectively. The back portion 3a comprises a back edge 3b which has the shape of a fin or ridge protruding from an upper end of the knife body 4. It extends continuously in the longitudinal direction of the knife and has the same height along its whole length, when being in its yet not deformed state. Accordingly, there is continuous linear contact between the edge of the back portion 3a and the support element 5 when they are assembled. The back portion 3a has a symmetric cross section (as seen in a longitudinal direction of the knife, corresponding to the only figure).The centre plane of the back portion 3a including the back edge 3b is coplanar with the centre plane of the edge 4. The back edge 3b has two opposite sides that are inclined with an angle a relative to each and meet at an end thereof, thereby forming a sharp edge with a radius r₁ in the range of 1-10 μm, preferably below 5 μm. In order to provide sufficient stability to the back edge 3b, the inclination angle a between the two sides of the back edge 3 is above 30°, preferably above 40° or even above 50°. In order to provide for sufficient deformability of the back edge 3b, the angle a is less than 70°, preferably less than 60°. The sides of the back edge 3b may be straight as depicted, or have curvature, concave or convex, or a more elaborate shape. In the alternatives with non-straight sides the angle a between the two sides should be understood as the angle between to imaginary lines going through the tip of the back edge and respective points on each sides of the back edge 3b where the back edge 3b meets the upper side of the knife body 4.

The back edge 3b of the punch knife 1 is softer than the rest of the knife in order to be more readily deformed than other parts of the knife. This has been achieved by means of local heat treatment thereof, preferably annealing, during the manufacturing process. The hardness of the back portion is preferably in the range of 250-320 HV, preferably below 300 HV, or around 66% of the hardness of the knife body 4 of the punch knife. The hardness is according to one embodiment, arranged to increase from the top of the back edge 3b towards its base, from around 66% to 76% of the hardness of the knife body 4.

The maximum width of the back edge 3b, i.e. at the base, is smaller than the width of the knife body 4. Accordingly, there is a shoulder 9 at the base of the back edge 3b, where the latter meets the knife body 4. There is a shoulder 9 on each side of the back edge 3b, and the shoulders 9 have corresponding sizes and shapes, thereby contributing to a symmetric cross section of the punch knife. Accordingly, only one shoulder 9 is described hereinafter. The intersection between the sides of the back edge 3b and the surface forming said shoulder is typically not sharp, but slightly rounded with a radius in the range of 5-50 μm, as indicated with r₂ in the figure. This has the technical effect of resulting in this transition region being less prone to cracking when the knife is subjected to a bending operation. The intersection between the shoulder surface and the sides of the knife body 4 is also slightly rounded and presents a radius r₃ in the range of 100-250 μm. This feature also helps to improve the ability of the punch knife 1 to smoothly go into the slot of the die board 7 during assembly, without any cutting interaction with the latter. The shoulder 9 forms a support section of the back portion 3a. The support section is utilized in the bending and/or mounting operations to provide a continuous reference and to bear a load that would otherwise had been on the back edge 3b, and which would have damaged the comparably compressible fin. In addition the punch knife becomes less hazardous to handle. In a region in which the shoulder 9 meets a side 10 of the knife body 4 the knife body 4 has a width which is smaller than the maximum width thereof, and said side 10 of the knife body 4 is inclined with an angle y with respect to a centre plane of the knife body 4. The inclined side 9 extends approximately 0.4-2 mm, before going over into a straight side 11, which is parallel with the centre plane of the punch knife. The inclination makes the mounting and dismounting in the die board easier.

The height h of the back edge 3b is in the range of 40-200 μm, preferably 100-150 μm. The height h chosen for a specific application will to a high degree depend on what kind of material that is to be punched, and the particular need of deformation of the back portion. If a larger deformation can be expected in order to achieve the requested self-levelling effect for a specific application, a correspondingly larger height should be provided.

The cutting edge 2 has hardness and a geometry that will promote retention of its shape while only the back portion 3a undergoes deformation during the self-levelling procedure. Accordingly, the cutting edge 2 is considerably harder than the back portion 3a. The hardness of the cutting edge 2 is above 500 HV, preferably in the range of 600-740 HV, preferably 640-700 HV, and is due to a local hardening of the cutting edge 3. Accordingly, it is also harder than the knife body 4. However, a too hard cutting edge will result in brittleness thereof, which may result in cracking when the knife is subjected to bending operations. Therefore, hardness above the defined upper limits should be avoided. As a result of the chosen hardness of the cutting edge 2 and the back portion 3a, the hardness of the back portion 3a is in the range of 35%-55% of the hardness of the cutting edge 2.

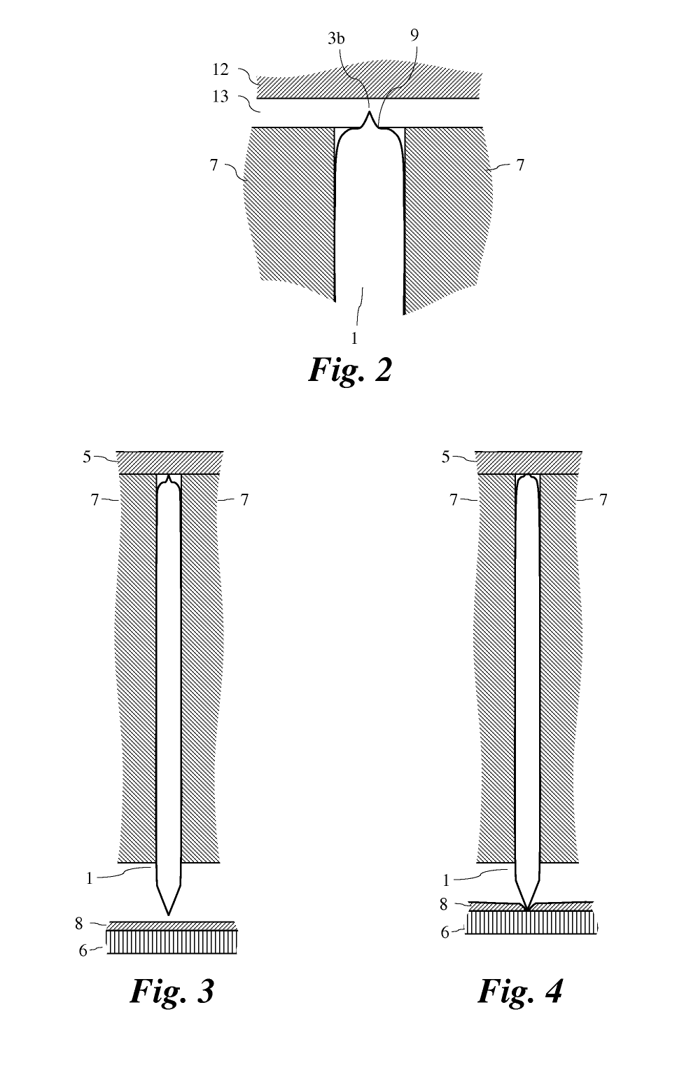

The load bearing function of the shoulder 9 is illustrated in FIG. 2. Prior to the assembling of the die board 7 and punch knife 1 in a die cutting machine the punch knife 1 is mounted to a fixture 7, the die board. Preferably, the die board 7 has the shape of a plate and is to be located adjacent to and in contact with the chase plate 5. Preferably, it is made of a wooden material, though other materials might also be used. The slot accommodating the punch knife 1 has a width generally corresponding to the thickness t of the punch knife 1 in order to enable firm holding of the latter by the die board 7. The thickness of the fixture 7 is considerable with regard to the height H of the punch knife 1 in order to enable firm support of the punch knife. During the mounting of the punch knife 1 according to the invention in fixture 7 an intermediate plate 13 with a thickness slightly larger than, the height of the back edge 3b is placed between the die board and a supporting surface 12 against which the die board 7 rests during punch knife mounting. The intermediate plate is made of a material such as card board or a polymer, e.g. nylon. As the punch knife 1 is knocked into the slots of the die board 7, the back edge 3b is permitted to cut into the intermediate plate 13, but the shoulder 9 will bear on the intermediate plate and prevent further motion and deformation of the back edge 3b. The combination of the back edge 3b being able to cut into the intermediate plate 13 and the shoulder 9 providing a firm support prevent the back edge 3b from being damaged in the process. Typically a number of punch knifes are mounted in the die board and form for example T-shaped intersections and joints. In the intersection and joints the knives have been machined to closely correspond to each other. It is of high importance that the cutting edges of two adjacent punch knives will be on exactly the same level. The combination of the back edge 3b cutting into and the shoulder 9 bearing on the intermediate plate 13 ensures that all punch knives in a die board will be levelled. This is in contrast to prior art punch knives which provides deformable back portions, but do not facilitate a controlled mounting. The intermediate plate 13 is only used during the mounting of the punch knife 1 in the die board 7 and is removed before the die board 7 is mounted in the die cutting machine.

FIG. 3 illustrated the die board 7 with the mounted punch knife 1 being assembled in the die cutting machine, prior to any punching operation. It should be noted that the actual set-up comprises more parts than here illustrated, only parts necessary to understand the function of the punch knife according to the invention have been included. A support element 5, normally a plate called the chase plate has been provided on top of the die board 7. During the assembling a slight motion of the punch knife 1 in the die board 7 will occur. As the punch knives were carefully levelled during the mounting operation described above and the motion is uniform and small, corresponding to the height h of the back edge 3b, this motion will not endanger the precision of the intersections and joints.

FIG. 4 illustrates the punch knife according to the invention during a punching operation. The die cutting machine also comprises a cutting plate 6 that carries the material 8 to be punched and that is moveably arranged in relation to the component formed by the support element 5 and the punch knife 1. The cutting plate 6 preferably has a flat surface on which the, preferably sheet-formed, material 8 to be punched is carried. During punching operation, the cutting plate 6 is moved towards the cutting edge 2 of the knife 1 such that the material 8 carried thereon is punched by the cutting edge 2 and until the latter is in continuous linear contact with the surface of the cutting plate 6. Whether it is the knife 1 or the cutting plate 6, or both of them, which is the moveable part is optional. After assembling the fixture 7 with the mounted punch knife 1 into the cutting machine one or a few initial punching operations are required before the production punching can start, corresponding to the patch-up procedure required if traditional punch knifes are used. During the initial punching a controlled plastic deformation of the back edge 3b is achieved thanks to the inventive design of the punch knife 1, as depicted in FIG. 4. The process can alternatively be described as the punch knife 1 settling in the fixture 7 during the initial punching, and a high degree of self-levelling is achieved. Some patch-up may still be needed to compensate for extensive wear of the cutting machine. However, also in such case the amount of patch-up is significantly reduced.

1. A steel punch knife for punching out parts of any shape from paper, cardboard, paperboard, corrugated board, plastics sheets, leather rubber and the like, comprising:
a knife body having a cutting edge at one end and a deformable back portion opposite the cutting edge, wherein the cutting edge is harder than the back portion; and
the back portion including a V-shaped back edge having two inclined sides defining an inclination angle between them, wherein the maximum width of the back edge, at the base thereof, is smaller than the width of the knife body, such that there is a shoulder at the base of the back edge where the back edge meets the knife body.

2. A punch knife according to claim 1, wherein the back edge has a symmetrical cross section and a center plane which is coplanar with a center plane of the knife body.

3. A punch knife according to claim 1 wherein the intersection between the sides of the back edge and a surface forming the shoulder is slightly rounded.

4. A punch knife according to claim 3, wherein the intersection between the sides of the back edge and the surface forming the shoulder has a radius (r₂) in the range of 5-50 μm.

5. A punch knife according to claim 3, wherein the intersection between the surface of the shoulder and the sides of the knife body is rounded.

6. A punch knife according to claim 5, wherein the intersection between the surface of the shoulder and the sides of the knife body presents a radius (r3) in the range of 100-250 μm.

7. A punch knife according to claim 2, wherein in a region where the shoulder meets a side of the knife body, the knife body has a width which is smaller than the maximum width thereof, and the side of the knife body is inclined with respect to a center plane of the knife body.

8. A punch knife according to claim 1, wherein the inclination angle between the inclined sides of the back edge is in the range of 30°-70°, and the edge of the back portion is sharp, having a radius in the range of 1-10 μm.

9. A punch knife according to claim 8, wherein the inclination angle between the inclined sides of the back edge is equal to or greater than 40°.

10. A punch knife according to claim 8 wherein the inclination angle between the inclined sides of the back edge is equal to or less than 60°.

11. A punch knife according to claim 8, wherein the radius (r₁) of the edge of the back edge is equal to or less than 5 μm.

12. A punch knife according to claim 1, wherein the back edge has a height in the range of 40-200 μm.

13. A punch knife according to claim 1, wherein the hardness of the back edge is in the range of 35%-64% of the hardness of the cutting edge.

14. A punch knife according to claim 1, wherein the back edge has a hardness that is equal to or less than 320 HV.

15. A punch knife according to claim 1, wherein the back edge has a hardness that is equal to or greater than 250 HV.

16. A punch knife according to claim 1, wherein the cutting edge has a hardness that is equal to or greater than 500 HV.

17. A punch knife according to claim 1, wherein the cutting edge has a hardness that is equal to or less than 740 HV.

18. A punch knife according to claim 1, wherein the back edge has a hardness that is equal to or less than 300 HV.

19. A punch knife according to claim 1, wherein the cutting edge has a hardness equal to or greater than 640 HV.

20. A punch knife according to claim 1, wherein the cutting edge has a hardness that is equal to or less than 700 HV.
